(19) United States
(12) Patent Application Publication
(10) Pub. No.: US 2015/0367385 A1
(43) Pub. Date: Dec. 24, 2015

(54) Mechanical Cleaner

(71) Applicant: Jennifer Kaplan, Northbrook, IL (US)

(72) Inventor: Jennifer Kaplan, Northbrook, IL (US)

(21) Appl. No.: 14/313,484

(22) Filed: Jun. 24, 2014

(51) Int. Cl. B08B 1/00; B08B 3/04; A47L 25/00

(52) U.S. Cl. CPC B08B 1/006; A47L 25/00; B08B 3/04

(57) ABSTRACT

A device and method for cleaning is provided having a power source, a rotational spindle operatively associated with said power source, a first solution container contained within said device, optionally, a second solution container contained within said device, an actuator, whereby said actuator initiates rotation of an interior spindle and delivers solution from each of said first solution chamber and second solution chamber through an outlet to the exterior of the device.

### BACKGROUND OF THE INVENTION

There are many devices that have been invented in order to provide for mechanical cleaning of surfaces. However, of all the devices developed, there is a shortcoming that has yet to be addressed. Currently, devices can provide mechanical cleaning and/or polishing and delivery of a cleaning solution outside the device. There is a need for a device configured with multiple interior solution chambers in order to effectively clean when multiple solutions are required and desired.

### SUMMARY OF THE INVENTION

In one embodiment, the present invention is a cleaning device comprising: a power source; a rotational spindle operatively associated with said power source; a solution container contained within said device; an actuator, whereby said actuator initiates rotation of an interior spindle and delivers solution from said solution chamber through an outlet to the exterior of the device.

In another embodiment, the present invention is a cleaning device comprising: a power source; a rotational spindle operatively associated with said power source; a first solution container contained within said device; a second solution container contained within said device; an actuator, whereby said actuator initiates rotation of an interior spindle and delivers solution from each of said first solution chamber and second solution chamber through an outlet to the exterior of the device.

The device cleaning head is removably attached to said rotational spindle. This provides for selection and changing of cleaning heads depending on particularized cleaning needs.

In one embodiment, the volume of solution delivered upon actuation is adjustable.

In one embodiment, the device is configured such that the solution is deliverable from the solution container to an outlet.

The device outlet is constructed and arranged to deliver solution onto a cleaning head.

The present invention also provides a method of cleaning, said method comprising the steps of:

providing a device according to the invention herein;
delivering a solution to said solution chamber;
attaching a cleaning head to said spindle;
actuating rotation of said spindle;
delivering said solution through said outlet;
directing said delivered solution to an article to be cleaned;
cleaning said article to be cleaned with different solutions of said delivered solution and said cleaning head.

In another embodiment, the present invention also provides a method of cleaning, said method comprising the steps of:

providing a device according to the invention herein;
delivering a first solution to said first solution chamber and a second solution to said second solution chamber;
attaching a cleaning head to said spindle;
actuating rotation of said spindle;
delivering at least one said first solution, said second solution, or combination thereof through said outlet;
directing said delivered solution to an article to be cleaned;
cleaning said article to be cleaned with each of said delivered solution and said cleaning head.

### BRIEF DESCRIPTION OF THE SEVERAL VIEWS OF THE DRAWING

FIG. 1 is a perspective separated view of one embodiment of the present invention.

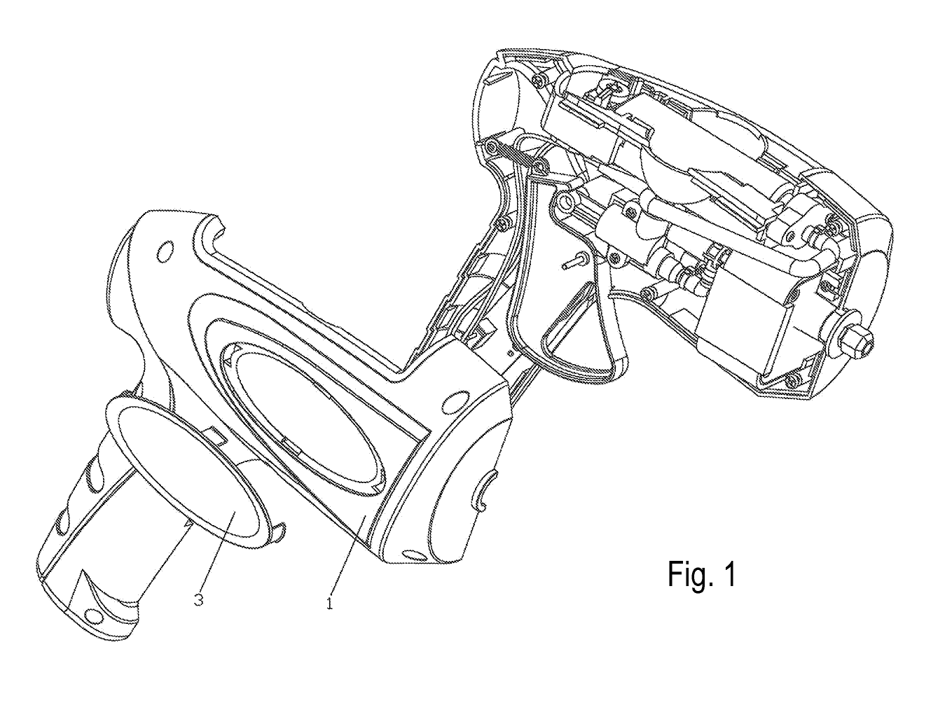

FIG. 2 is a side view of one embodiment of the present invention.

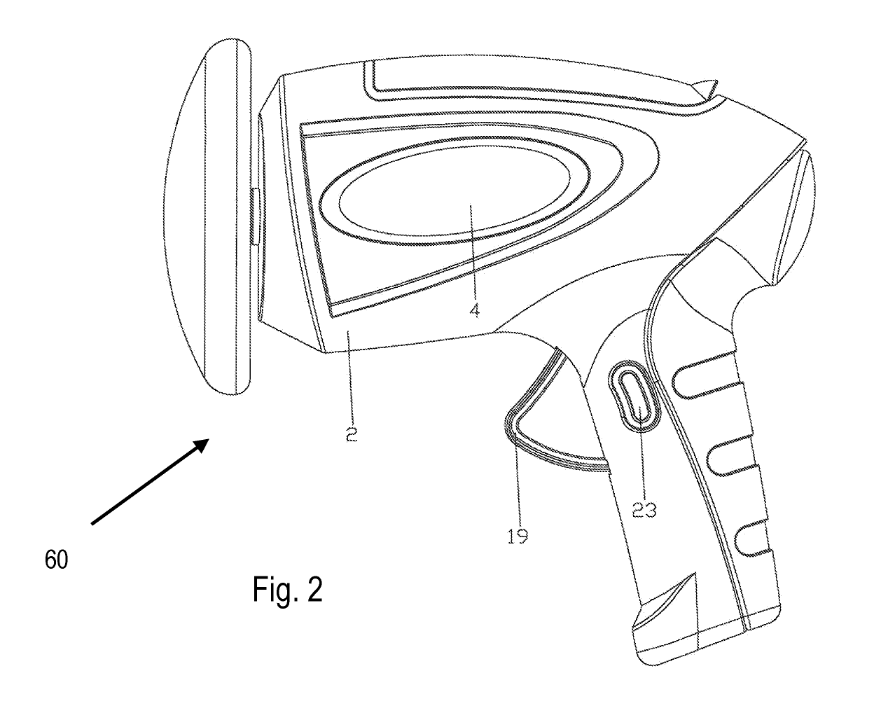

FIG. 3 is a perspective separated view according to the present invention.

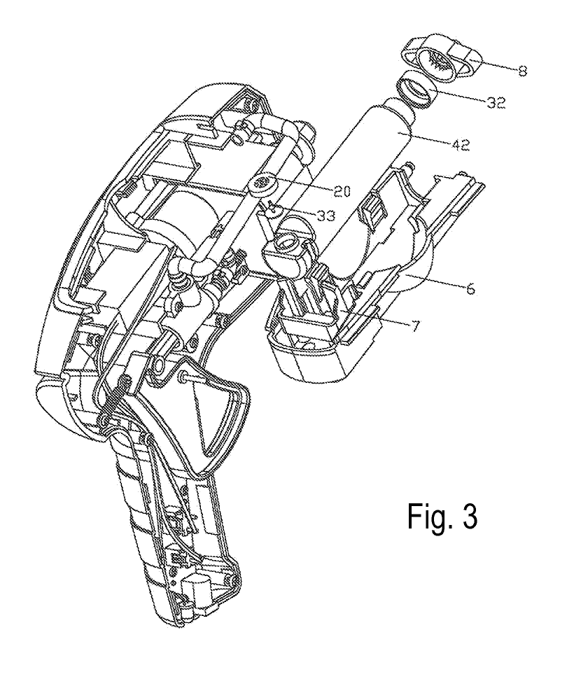

FIG. 4 is a perspective view according to the present invention.

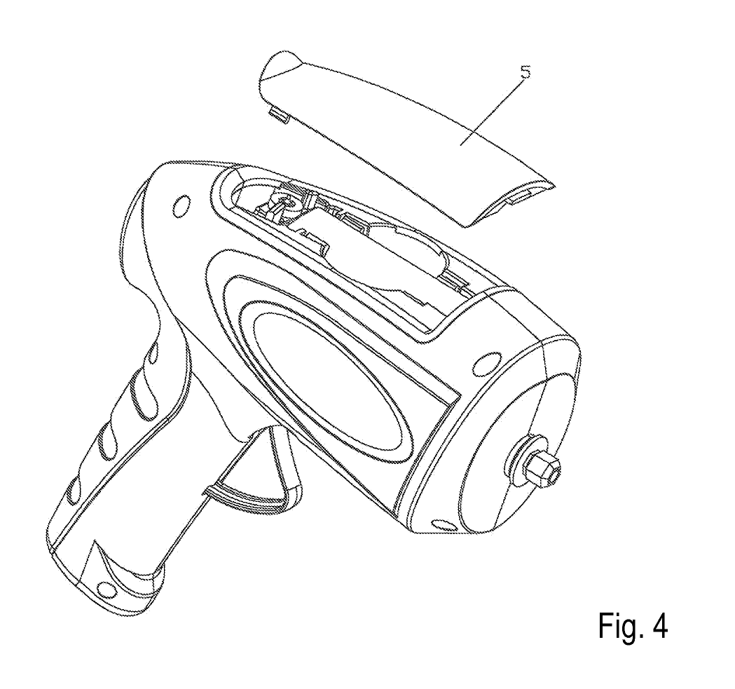

FIG. 5 is a partial separated perspective view according to the present invention.

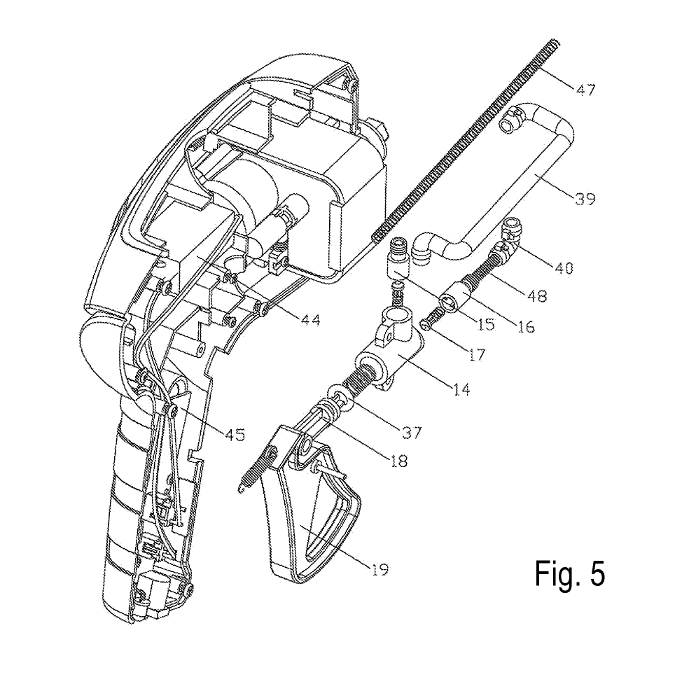

FIG. 6 is an expanded view of internal components according to the present invention.

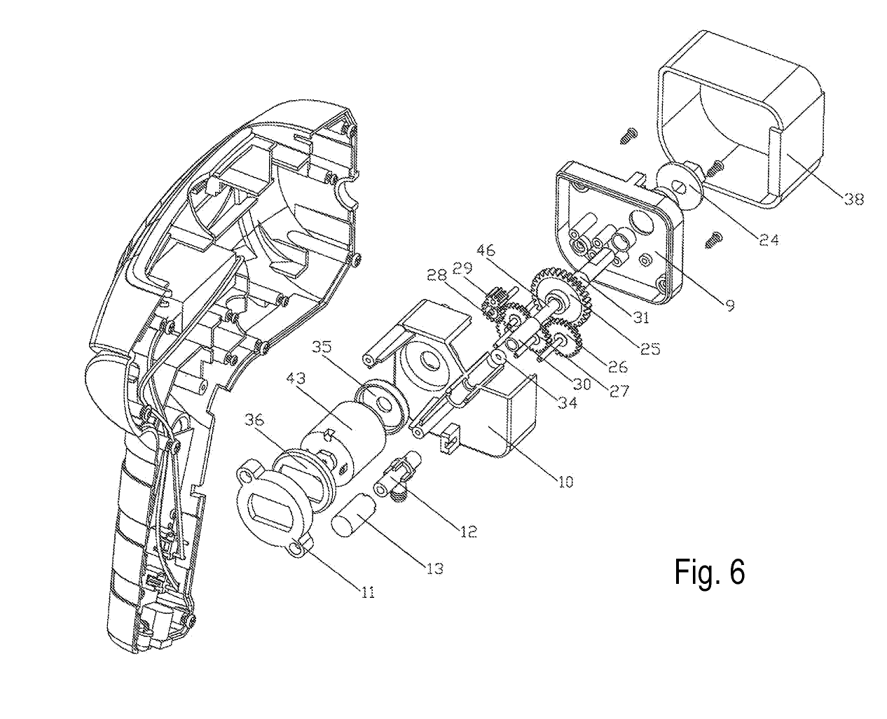

FIG. 7 is a perspective progressive view of attachment components according to the present invention.

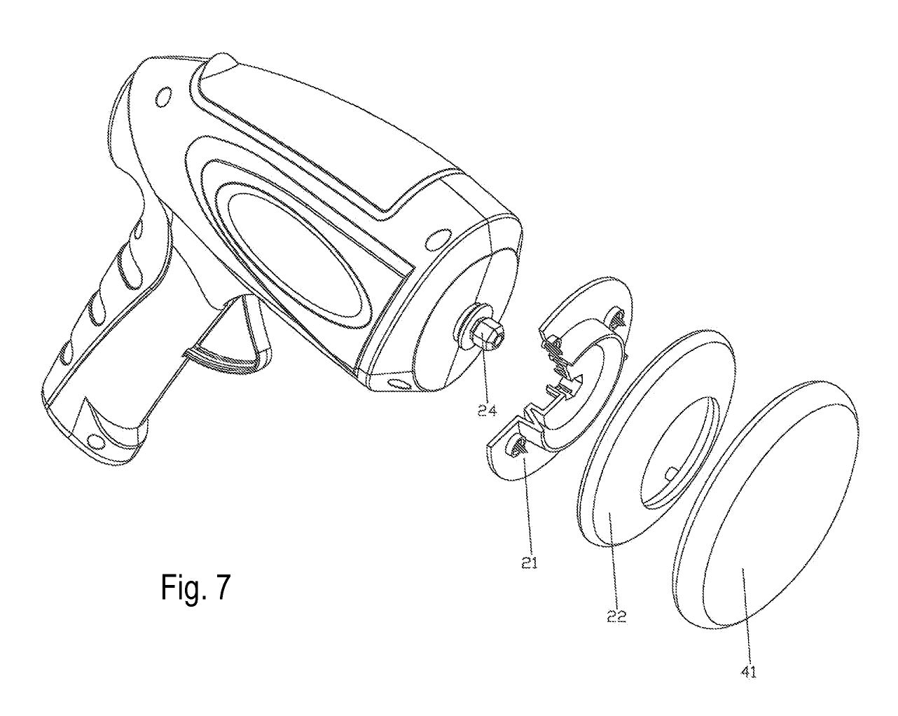

FIG. 8 is an exploded view of component of one embodiment of the present invention.

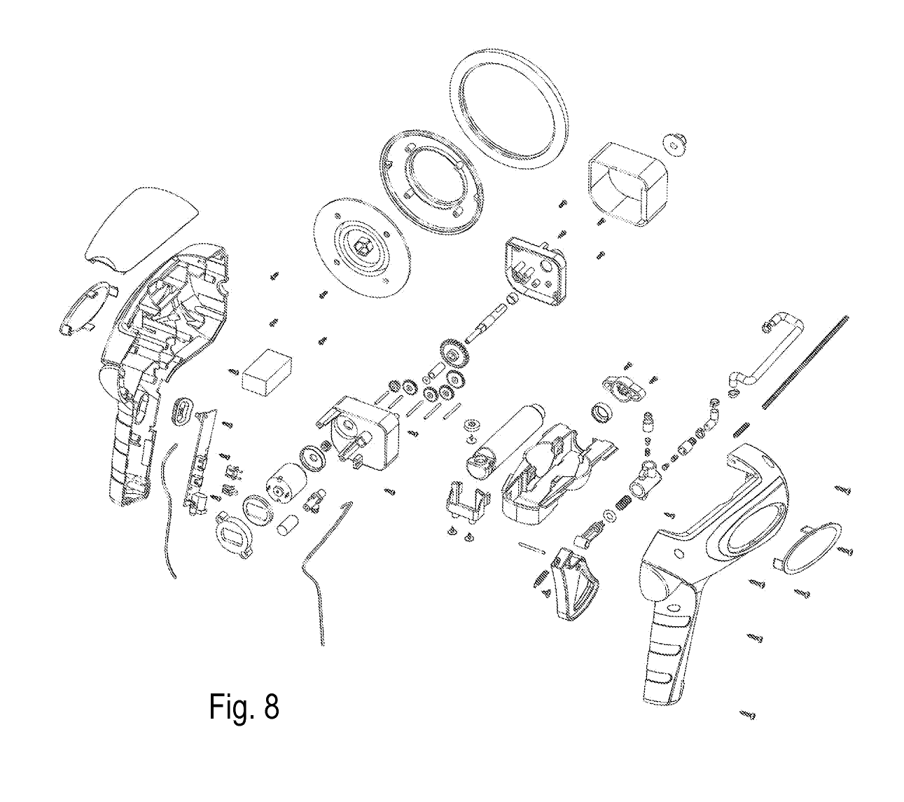

### DETAILED DESCRIPTION OF THE PREFERRED EMBODIMENT

The present invention as generally understood is a hand-held device 60 with a terminal end having a rotational spindle. Incorporated within the device of the present invention is a solution container constructed and arranged to deliver a cleaning solution to a cleaning head attached to said rotatable spindle. In one embodiment, a cleaning sponge 41 or other similar article is adapted in front of a front turntable housing 22. Said housing is affixed to a back turntable housing 21. Each of said front housing 22 and back housing 21 constructed and arranged to interact with a rotatable spindle 24. The overall device forms a single unit with a right housing portion 1 and a left housing portion 2. Optionally, either or both housing 2 and housing 3 have right removable cover 3 or left removable cover connected thereon. Device 60 also has removable top cover 5 affixed thereto. A solution container 6 is constructed and arranged with a delivery means 7 for directing solution from solution container 6. In one embodiment, delivery means 7 is a solution pump operatively associated with actuator 19. One configuration provides a single solution pump for delivery of all fluids from one or more solution containers. In one embodiment, each solution container has one or more dedicated pump.

In one embodiment, a solution container 42 is constructed and arranged with a solution inlet valve 20 that mates with inlet 32 that provides delivery of solution on demand. An actuator 19 initiates delivery of solution. Container 42 has gasket 32 positioned between bottle 42 and outlet cover 8. In one embodiment, actuator 19 is a trigger or trigger-type device. In one embodiment more than on actuator 19 is present and each actuator separately controls solution delivery and spindle rotation. Actuator 19 is operatively associated with bump push rod 18 that is secured in position by bump push rod O-ring 37.

In one embodiment, actuator 19 is disabled by main power switch 23 on the body of device 60. Bump push rod 18 is covered with bump cover 14, and bump cover 14 is configured with bump inlet pipe 15 and pump outlet pipe 16 that direct solution through first delivery pipe 40. Second delivery pipe 39 is further associated with pump inlet 15 and has pipe actuation spring 47 contained therein.

In one embodiment, motor 43 is powered by battery 44 and action of the device is regulated by circuit board 45. In one embodiment, the device further includes a plurality of gears for rotating spindle 24. In one embodiment, a first gear 28, a second gear 27, and a third gear 26 are rotated by motor gear 29, dependent upon first gear box casing 30. In one embodiment, first gear box casing 30 is a long casing. Second gear box casing 31, which in one embodiment is a short casing, is constructed and arranged to pass through an orifice in front housing gear box 9 and ultimately rotate spindle 24. Motor over 11 is positioned proximal to back housing gear box 10 and positioned between each are inlet pipe of gear box 12 inlet pipe casing of gear box 13, motor 43 with motor rear pad 35. Adapter coupling 25 around outlet 46 whereby motor gear 29 interacts and ultimately turns each of first gear 28 second gear 27 and third gear 26. Gearbox long casing 30 connects with waterproof adapter ring 34. Gearbox pad 38 provides protection from adverse vibrational motion. In one embodiment, the solution outlet is through an interior channel of spindle 24 and directs solution onto an attached cleaning head.

In one embodiment, the device is constructed and arranged to contain each of water and a cleaning solution in separate solution reservoirs. It is further contemplated that the device be constructed and arranged to deliver predetermined amounts of water and cleaning solution, either simultaneously or in a predetermined succession. The water and/or water/cleaning solution combination is delivered ultimately to cleaning head 41.

In a preferred embodiment, a leather soap or leather conditioner is deposited within the device of the present invention. The device is actuated and liquid is delivered to cleaning sponge 41. Cleaning sponge 41 rotates and a user applies cleaning sponge 41 to a surface to be cleaned. In one contemplated embodiment, the device is used to clean and/or police leather. Further, cleaning of leather can include the process of utilizing various leather conditioners. As is noted in the art, leather conditioners can include many different types of substances and the device of the present invention is contemplated as being suitable and configurable for use with leather soaps, conditioners, cleaners, and the like.

In a preferred embodiment, cleaning sponge 41 is removable and interchangeable such that a user can select particular sponge material dependent on a desired operation.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A cleaning device comprising: a power source; a rotational spindle operatively associated with said power source; a first solution container contained within said device; optionally, a second solution container contained within said device; an actuator, whereby said actuator initiates rotation of an interior spindle and delivers solution from each of said first solution chamber and second solution chamber through an outlet to the exterior of the device.

2. The device of claim 1 whereby a cleaning head is removably attached to said rotational spindle.

3. The device of claim 1 whereby the volume of solution delivered upon actuation is adjustable.

4. The device of claim 1 whereby solution is individually selectable deliverable from at least one solution container to an outlet.

5. The device of claim 1 whereby said outlet is constructed and arranged to deliver solution onto a cleaning head.

6. A method of cleaning, said method comprising the steps of:
providing a device according to claim 1;
delivering a solution to said chamber;
attaching a cleaning head to said spindle;
actuating rotation of said spindle;
delivering a solution through said outlet;
directing said delivered solution to an article to be cleaned;
cleaning said article to be cleaned with each of said delivered solution and said cleaning head.
